(19) United States
(12) Patent Application Publication
(10) Pub. No.: US 2006/0183372 A1
(43) Pub. Date: Aug. 17, 2006

(54) Quick connector for fuel piping

(76) Inventor: Nobuaki Niki, Inuyama-shi (JP)

Correspondence Address: ANDRUS, SCEALES, STARKE & SAWALL, LLP, 100 EAST WISCONSIN AVENUE, SUITE 1100, MILWAUKEE, WI, 53202, US

(21) Appl. No.: 11/355,054

(22) Filed: Feb. 15, 2006

(30) Foreign Application Priority Data
Feb. 16, 2005 (JP) 2005-039834
Feb. 16, 2005 (JP) 2005-039835

(51) Int. Cl. H01R 13/73

(52) U.S. Cl. 439/552

(57) ABSTRACT

A quick connector for a fuel piping is constituted by a connector main body having a vertical insertion pipe inserted and fitted into an insertion hole of an mating side installed equipment and a nipple portion formed laterally with respect to the insertion pipe, and an elastic hook portion having a latching hook elastically latched to a latched portion provided in the installed equipment. The elastic hook portion may be structured as an independent body from the connector main body. Or the latching hook may be structured such as to be latched to the latched portion inward from an outer side.

### BACKGROUND OF THE INVENTION

1. Field of the Invention

The present invention relates to a quick connector for a fuel piping which is attached to a fuel line equipment, for example, an installed equipment such as a fuel tank and is adapted for coupling the fuel piping to the installed equipment.

2. Description of Related Art

In the past, a quick connector has been used as a structure for coupling a fuel piping such as a fuel transport tube to an installed equipment such as a fuel tank and a fuel pump of a motor vehicle. FIG. 18 shows an example thereof (patent document 1 mentioned below). In the drawing, reference numeral 200 denotes a quick connector. The quick connector 200 has a vertical insertion pipe 206 inserted and fitted into an insertion hole 204 formed in an installed equipment 202 such as a fuel tank, a fuel pump, a connector main body 210 formed sideways with respect to the insertion pipe 206 and having a tubular nipple portion 208 inserted into an inner portion of a fuel piping such as a fuel transport tube, and an elastic hook portion 211 integrally provided in the connector main body 210 for fixing the connector main body 210 to the installed equipment 202 in a come-off preventing state. The elastic hook portion 211 integrally has an elastic leg 212, and a latching hook 214 is integrally formed in an end portion (a leading end portion) of the elastic leg 212 in the installed equipment 202 side.

On the other hand, an annular latched body 216 is integrally provided in a side of the installed equipment 202. The latched body 216 has a notched portion 218 formed in a circular arc shape, and a latched portion 220 formed in an upper side thereof.

In the case of the quick connector 200 shown in FIG. 18, it is possible to rapidly attach the quick connector 200 or the connector main body 210 to the installed equipment 202 in the come-off preventing state, by inserting the insertion pipe 206 to the insertion hole 204 of the installed equipment 202 in an axial direction, and latching the outward latching hook 214 in the leading end portion of the elastic leg 212 to the latched portion 220 of the latched body 216 in the installed equipment 202 side from an inner side toward an outer side while elastically deforming the elastic leg 212 of the elastic hook portion 211 inward. Further, it is possible to make the fuel piping and the installed equipment 202 in a coupled state via the quick connector 200 mentioned above, by attaching the quick connector 200 to the installed equipment 202.

However, in the case of the quick connector 200, if it is intended to set the diameter of the nipple portion 208 or the like to a proper value correspondingly in the case that the piping diameter of the fuel piping, the type of the piping or the like is changed, and so on, it is necessary to replace the entire quick connector 200. In other words, it is necessary to prepare the exclusive quick connector 200 corresponding to the piping diameter, the type or the like of each of the fuel pipings, and the cost is necessarily increased.

Further, in the quick connector 200, there is a risk that the connector main body 210 in which the lower portion of the insertion pipe 206 is inserted into the insertion hole 204 of the installed equipment 202 is tilted with respect to an axis line of the insertion pipe 206 due to a vehicle body vibration. If the tilting motion is generated in the connector main body 210, an O-ring 222 for sealing shown in FIG. 18C is rubbed and damaged, and there is a risk that a sealing performance is lowered.

In this case, there can be considered to suppress the tilting motion of the connector main body 210 caused by the vehicle body vibration by bringing the latched portion 220 of the latched body 216 fixed to the installed equipment 202 into contact with an outer peripheral surface of the insertion pipe 206 in a front side (an upper side) of the installed equipment 202 in a lateral direction (in an axial perpendicular direction), and stabilizing an installed attitude of the connector main body 210. However, the latching hook 214 is outward directed to the insertion pipe 206 in the connector main body 210, and is latched to the latched portion 220 outward from an inner side. As mentioned above, in the case that the latching hook 214 is formed as the outward latching hook, and latches outward to the latched portion 220 from the inner side, the tilting motion suppressing means mentioned above can not be achieved or configured.

Further, in the case of the quick connector 200, since it is necessary to directly apply an inward operating force to the elastic leg 212 at a time of canceling the latching of the latching hook 214 with respect to the latched portion 220, there is a problem that it is necessary to operate this by a strong force. Further, considering the latching canceling operation, it is necessary to form the elastic leg 212 long. In this case, a latching force of the latching hook 214 with respect to the latched portion 220 becomes relatively weak.

In this case, the quick connector 200 is attached to the installed equipment 202 in such a manner that the direction of the nipple portion 208 (the position in the rotational direction of the insertion pipe 206 around the axis) is always fixed. The position in the rotational direction of the nipple portion 208 defines a direction in which the fuel piping connected thereto extends out from the quick connector 200. In this case, if the position in the rotational direction of the nipple portion 208 is fixed to a predetermined position, the following problems are generated. The proper direction that the fluid piping extends differs depending on the vehicle type. If the extending direction is improper, it is necessary to arrange the fuel piping while lengthily routing (bending) the fuel piping, and a piping length becomes necessarily long.

As a matter of fact, there can be considered a matter that the quick connector 200 is attached to the installed equipment 202 in a freely rotating state, that is, the nipple portion 208 is made rotatable.

With this structure, even in the case that the proper extending direction of the fuel piping is variously different, it is possible to correspond thereto by freely changing the position in the rotational direction of the nipple portion 208. However, if the quick connector 200, that is, the nipple portion 208 is in the rotatable state around the axis center of the insertion pipe 206, there is generated a problem that the fuel piping such as the fuel transport tube connected thereto generates an oscillation accompanied by the rotating motion of the nipple portion 208 on the basis of the vehicle traveling. Accordingly, it is necessary to fasten the fuel piping to the vehicle body or the like by an additional clamp part. In this case, a clamp part is required additionally for suppressing the oscillation of the fuel piping, and there is a problem that a work for fixing the portion of the fuel piping in the vicinity of the quick connecter by the clamp part is necessary at a time of assembling the fuel piping in the vehicle body.

[Patent Document 1]

Japanese Unexamined Patent Publication No. 2001-208265

The present invention is made by taking the circumstances mentioned above into consideration, and an object of the present invention is to solve at least one of the problems mentioned above.

### SUMMARY OF THE INVENTION

In accordance with the present invention, a novel quick connector for a fuel piping is provided. The novel quick connector for the fuel piping is provided with (a) a connector main body having a vertical insertion pipe inserted and fitted into an insertion hole of an mating side fuel line equipment (for example, a mating side installed equipment) such as a fuel tank, and a tubular nipple portion formed laterally with respect to the insertion pipe and inserted into the fuel piping, and (b) an elastic hook portion including an elastic leg having a latching hook elastically latched to a latched portion provided in the fuel line equipment in a leading end portion in the fuel line equipment side, and elastically latching to the latching hook to the latched portion by being pressed in an axial direction so as to fix the connector main body to the fuel line equipment in a come-off preventing state. The elastic hook portion may be structured such that the latching hook is formed inward with respect to the insertion pipe and latched to the latched portion inward from an outer side or the elastic hook portion may include a come-off preventing portion achieving a come-off prevention on the basis of an abutting action or an abutment against the connector main body, and may be structured as an independent body from the connector main body.

In the case that the elastic hook portion is provided with the come-off preventing portion achieving the come-off prevention on the basis of the abutting action or the abutment against the connector main body, and the elastic hook portion is structured as the independent body from the connector main body, it is possible to arrange a positioning means defining a position in a rotational direction of the insertion pipe or the nipple portion of the connection main body around an axis of the insertion pipe with respect to the elastic hook portion, astride the connector main body and the elastic hook portion. The positioning means connects the connector main body with the elastic hook portion in non-rotatable relation while defining a position in a rotational direction of the connector main body with respect to the elastic hook portion.

The positioning means can be structured such as to be capable of positioning the connector main body to each of a plurality of different positions in the rotational direction with respect to the elastic hook portion. Further, the positioning means can be structured such as to have an engagement protruding portion provided to one of the connector main body and the elastic hook portion, and an engagement concave portion provided to the other, and position the connector main body on the basis of an engaging operation therebetween. Further, the positioning means can be structured such as to have an engagement protruding portion provided to one of the connector main body and the elastic hook portion, and an engagement concave portion provided to the other, and the positioning means can be also structured such that the engagement protruding portion and the engagement concave portion are engaged so as to be non-rotatable with each other at different positions in the rotational direction. The engagement protruding portion and the engagement concave portion can be structured such as to be capable of positioning the connector main body to each of a plurality of different positions in the rotational direction with respect to the elastic hook portion.

The structure can be made such that the engagement protruding portion is formed in a plate shape, and the engagement concave portion is formed in a slit shape corresponding to the plate shape.

The structure can be made such that the elastic hook portion is formed in a gantry shape provided with at least a pair of elastic legs and a coupling portion coupling the elastic legs in an end portion in an opposite side to the latching hook, and the coupling portion operates as the come-off preventing portion.

Further, in the case that the elastic hook portion is structured such that the latching hook is formed inward with respect to the insertion pipe and latched to the latched portion inward from an outer side, or the elastic hook portion includes a come-off preventing portion achieving a come-off prevention on the basis of an abutting action or an abutment against the connector main body, and is structured as an independent body from the connector main body, the structure can be made such that the latching hook enters into a notched portion formed in a side of the fuel line equipment so as to be latched to the latched portion, and a length of the notched portion is set to a length at which the latching hook does not rotationally move within the notched portion. In this case, the structure can be made such that the notched portion is provided at a plurality of positions around the insertion hole, and the latching hook enters into any one of the notched portions so as to be latched to the latched portion.

In the case that the elastic hook portion is structured such that the latching hook is formed inward with respect to the insertion pipe, and latched to the latched portion inward from the outer side, the structure can be made such that the latched portion is formed in a latched body provided in a front side of the fuel line equipment in a fixed state, and is positioned around the insertion pipe in the connector main body in the front side of the fuel line equipment. In this case, the elastic hook portion can be integrally provided in the insertion pipe of the connector main body. Further, the elastic hook portion may be provided with a release knob canceling the latching of the latching hook with respect to the latched portion on the basis of a lever operation.

As mentioned above, in accordance with the present invention, since the structure can be made such that the elastic hook portion is structured as the independent body with respect to or from the connector main body having the vertical insertion pipe and the lateral nipple portion, and the elastic hook portion is provided with the elastic leg having the latching hook in the leading end portion and the come-off preventing portion preventing the come-off on the basis of the abutting action or the abutment with respect to the connector main body, the elastic hook portion can be used in common with each of the connector main bodies even in the case of changing to or providing the connector main body having the proper nipple portion corresponding to the difference in the piping diameter, the piping type or the like of the fuel piping. Accordingly, it is possible to make the cost required for the quick connector inexpensive.

In this case, it is possible to arrange the positioning means for defining the position in the rotational direction of the connector main body with respect to the elastic hook portion, that is, the position in the rotational direction of the nipple portion, around the axis of the insertion pipe with respect to the elastic hook portion, astride the connector main body and the elastic hook portion. With this structure, it is possible to suppress the oscillation of the fuel piping accompanied by the vehicle traveling on the basis of the free rotation of the connector main body, that is, the nipple portion, by setting the position in the rotational direction of the elastic hook portion to the fixed state with respect to the fuel line equipment. Accordingly, it is possible to omit fixing of the portion in the vicinity of the connector of the fuel piping to the vehicle body or the like by the independent clamp part for suppressing the oscillation, and it is possible to omit such a clamp part and fixing work. The positioning means positions the connector main body while defining a position in a rotational direction of the connector main body with respect to the elastic hook portion.

In this case, the positioning means can be structured such as to be capable of positioning or fixing the connector main body to each of a plurality of different positions in the rotational direction with respect to the elastic hook portion. With this structure, it is possible to change the direction or orientation of the nipple portion, that is, the position in the rotational direction of the nipple portion around the axis of the insertion pipe corresponding to the proper extending direction of the fuel piping, whereby it is possible to eliminate the necessity that the fuel piping is unnecessarily lengthily routed, and it is possible to effectively shorten the piping length. Further, since it is possible to set the direction of the nipple portion to the fixed state, that is, the freely non-rotatable state under the state in which the quick connector is attached to the fuel line equipment, while making the direction of the nipple portion variable at a time of the attaching work, it is possible to omit the fixing work by a clamp part in the vicinity of the connector of the fuel piping in order to restrain the free rotation of the nipple portion, while making the direction of the nipple portion variable.

In this case, the positioning means can be structured such as to have the engagement protruding portion provided to one of the connector main body and the elastic hook portion, and the engagement concave portion provided to the other, and position the nipple portion or the connector main body on the basis of the engagement operation thereof. With this structure, the positioning means can be structured with a simple structure.

If the structure is made such that the engagement protruding portion and the engagement concave portion can be engaged with each other at each of the different positions in the rotational direction so as to be non-rotatable, it is possible to attach the quick connector to the fuel line equipment in a state in which the direction (the position in the rotational direction) of the nipple portion is directed to a desired direction, and it is possible to prevent the free rotation of the nipple portion after attaching. For example, the positioning means is structured such that a plurality of the engagement concave portions are formed so as to extend in different directions, and so as to allow the engagement protruding portion to selectively engage with one of the engagement concave portions.

If the engagement protruding portion is formed in a plate shape, and the engagement concave portion is formed in a slit shape corresponding to the plate shape, it is possible to make a regulating force in the rotational direction large.

If the structure is made such that the latching hook is entered into the notched portion formed in the side of the fuel line equipment so as to be latched to the latched portion, and the length of the notched portion is set to the length at which the latching hook does not rotationally move within the notched portion, it is possible to retain the latching hook itself to the fuel line equipment in the non-rotatable state, that is, to set the elastic hook portion to the fixed state in the rotational direction with respect to the fuel line equipment. With this structure, it is possible to attach and fix the connector main body and the elastic hook portion integrally to the fuel line equipment in a state of being defined at the position in the rotational direction.

Next, if the structure is made such that the notched portion is provided at a plurality of positions around the insertion hole, and the latching hook is entered into any one of the notched portions so as to be latched to the latched portion, it is possible to make the attaching position of the elastic hook portion itself with respect to the fuel line equipment variable at the position in the rotational direction. In other words, in this case, the notched portions provided at a plurality of positions form a positioning means or a positioning mechanism for making the position in the rotational direction of the quick connector, that is, the nipple portion variable at a time of the attaching work and in the fixed state after attaching.

In this case, the notched portion mentioned above can be structured such as to generate a play gap between the latching hook within the notched portion and the longitudinal end of the notched portion. With this structure, in the case that it is desired to finely determine the direction of the fuel piping such as the fuel transport tube or the like according to the layout per the vehicle type, the direction of the nipple portion can be regulated by the play gap.

Further, if the structure is made such that the latched portion, to which the latching hook in the elastic hook portion is latched, is positioned around the insertion pipe of the connector main body in the front side of the fuel line equipment, and the latching hook is formed inward so as to be latched inward to the latched portion from the outer side, it is possible to structure such that the latched portion is laterally brought into contact with the outer peripheral surface of the insertion pipe in the front side of the fuel line equipment, that is, to structure such that the latched portion serves as a stopper in an axial perpendicular direction with respect to the insertion pipe. Accordingly, it is possible to effectively suppress the tiling motion of the quick connector attached and fixed to the fuel line equipment, and it is possible to hold the quick connector in a stable attitude even in the case that the vehicle body vibration is applied.

Accordingly, it is possible to solve the risk that the seal ring sealing between the quick connector and the insertion hole is rubbed or damaged due to the tiling motion of the quick connector, whereby the sealing performance is lowered. Further, in accordance with this structure of the present invention, it is possible to easily add such release knob canceling the latching of the latching hook with respect to the latched portion on the basis of the lever operation.

For example, in the case of the quick connector shown in FIG. 18, if it is intended to add the release knob canceling the latching on the basis of the lever operation, the release knob is configured so as to be pushed outward from the inner side. Accordingly, in the quick connector in FIG. 18, it is practically hard to add the release knob. In addition, even if the release knob mentioned above is provided, it is hard to operate the release knob.

Accordingly, in this case, since the latching hook is structured such as to latch itself to the latching portion inward from the outer side, the release knob can be easily provided, and the release knob can be structured such that the latching is cancelled by applying the force inward, whereby it is possible to easily execute the release cancel by a small force. Further, in the case that the release knob mentioned above is provided, it is not necessary to cancel the latching by directly applying the force for canceling to the elastic leg itself. Accordingly, it is possible to make the elastic force of the elastic leg strong so as to make the latching force of the latching hook with respect to the latched portion strong. In this case, it is possible to further stabilize the attitude of the quick connector.

Now, a description will be given in detail of an embodiment in accordance with the present invention with reference to the accompanying drawings.

### BRIEF DESCRIPTION OF THE DRAWINGS

FIG. 1 is a perspective view showing a first quick connector for a fuel piping in accordance with an embodiment of the present invention in a state of being attached to an installed equipment;

FIG. 2 is a view showing the first quick connector in an exploded state;

FIG. 3 is a cross sectional view of the first quick connector;

FIG. 4 is a top elevational view of the first quick connector;

FIG. 5 is an explanatory view of an operation at a time of defining a position in a rotational direction of a nipple portion in the first quick connector;

FIG. 6A is a view showing a first modified embodiment in connection with the first quick connector for the fuel piping;

FIG. 6B is a view showing a second modified embodiment in connection with the first quick connector for the fuel piping;

FIG. 7A is a view showing a third modified embodiment in connection with the first quick connector for the fuel piping;

FIG. 7B is a view showing a fourth modified embodiment in connection with the first quick connector for the fuel piping;

FIG. 8 is a view showing a second quick connector in accordance with an embodiment of the present invention in an attached state;

FIG. 9 is a view showing the second quick connector together with a peripheral portion in a state before being attached;

FIG. 10 is a partly notched plan view of the second quick connector;

FIG. 11 is a cross sectional view cut along a line XI-XI in FIG. 10;

FIG. 12 is an explanatory view of an operation of the second quick connector;

FIG. 13 is a view showing a main portion of a first modified embodiment of the second quick connector;

FIG. 14 is a partly notched plan view of the embodiment in FIG. 13;

FIG. 15A is a view showing a main portion of a second modified embodiment of the second quick connector;

FIG. 15B is another view showing the main portion of the second modified embodiment of the second quick connector;

FIG. 16 is an explanatory view of an operation of the embodiment in FIG. 15;

FIG. 17A is a view showing a main portion of a third modified embodiment of the second quick connector;

FIG. 17B is another view showing the main portion of the third modified embodiment of the second quick connector;

FIG. 18A is a perspective view showing a conventionally known quick connector; and

FIG. 18B is a cross sectional view showing the conventionally known quick connector.

### DETAILED DESCRIPTION OF THE PREFERRED EMBODIMENT

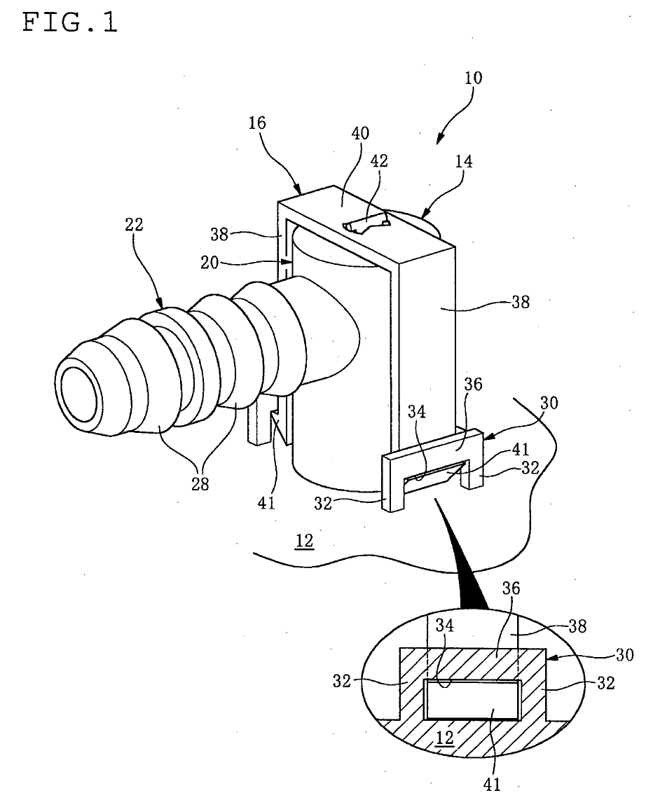

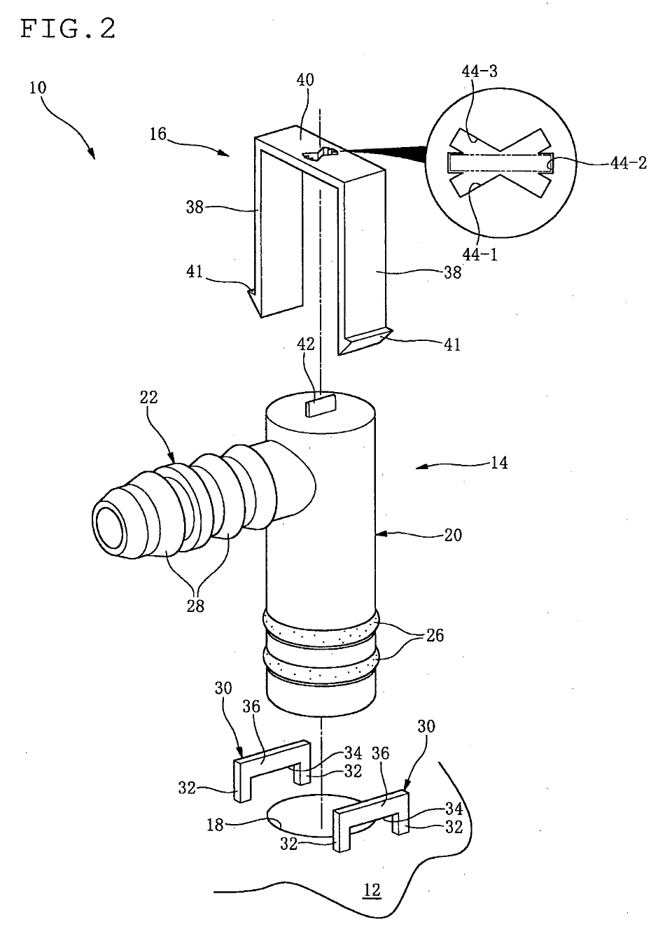

In FIGS. 1 to 3, reference numeral 10 denotes a first quick connector attached to an installed equipment (a fuel line equipment) 12 such as a fuel tank or a fuel pump of a motor vehicle, and that couples a fuel piping such as a fuel transport tube to the installed equipment 12. The first quick connector 10 has a connector main body 14 and a hook member (an elastic hook portion) 16 formed as an independent body from the connector main body 14. As shown in FIG. 2, the connector main body 14 integrally has a vertical insertion pipe 20 inserted and fitted into an insertion hole 18 of the installed equipment 12, and a tubular nipple portion 22 formed in a perpendicularly lateral direction to the insertion pipe 20 and inserted into an inner portion of the fuel piping.

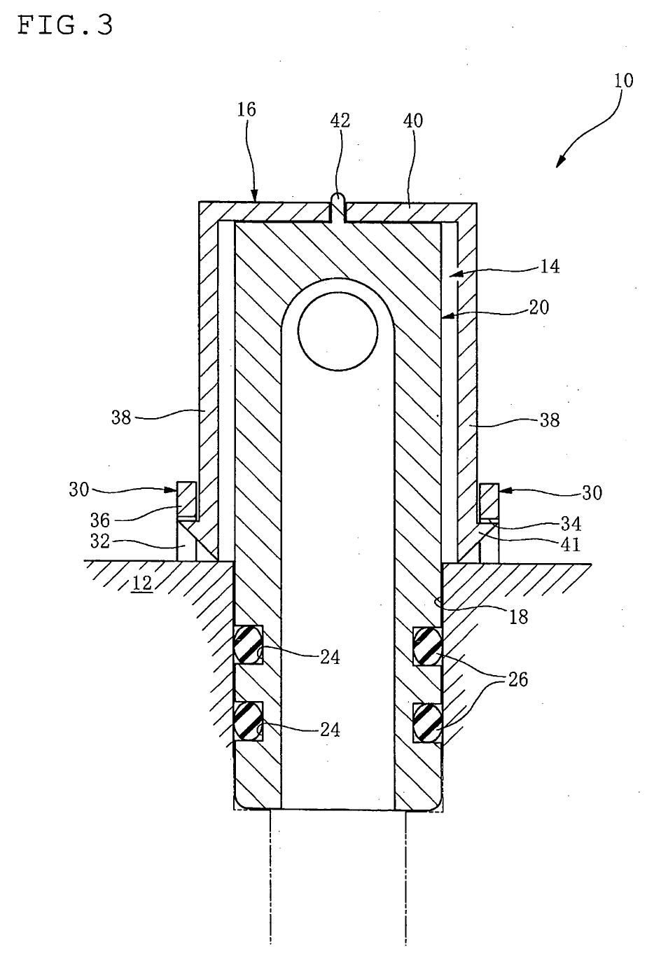

In the insertion pipe 20, an annular O-ring groove 24 is formed on an outer peripheral surface at a position within the insertion hole 18 as shown in FIG. 3, and an O-ring 26 serving as a seal ring is installed thereto. The insertion pipe 20 is sealed in a liquid-tight manner to an inner surface of the insertion hole 18 by the O-rings 26 under a state in which the insertion tube 20 is inserted and fitted into the insertion hole 18.

On the other hand, annular come-off preventing projections 28 are provided at a plurality of positions in an axial direction on an outer peripheral surface of the laterally formed nipple portion 22, as shown in FIGS. 1 and 2. The annular come-off preventing projections 28 allow the nipple portion 22 to move in an inserting direction with respect to the fuel piping at a time of inserting the nipple portion 22 to the fuel piping. On the other hand, an outer end portion thereof in an outer periphery formed at an acute angle eats into the inner portion of the fuel piping so as to achieve a come-off preventing operation in a come-off direction with respect to the fuel piping.

A pair of latching bodies (latched bodies) 30 formed in a C-shape as shown in FIG. 2 are integrally provided on a surface (an upper surface) of the installed equipment 12. Each of the latching bodies 30 has a pair of legs 32 and a notched portion 34 at a position between the legs 32 and 32, and is provided with a latched portion 36 connecting the pair of legs 32 and 32 in an upper side of the notched portion 34.

The hook member 16 is formed as a gantry shape as a whole, and integrally has plate-like elastic legs 38 extending in parallel with each other in a downward direction in the drawing, and a come-off preventing portion 40 serving as a plate-like coupling portion coupling upper ends in the drawing of the elastic legs 38. In this case, the come-off preventing portion 40 executes a function of preventing the connector main body 14 from coming off from the insertion hole 18, on the basis of an abutting action against the connector main body 14, in more detail, an abutting action against a top surface of the connector main body 14 (refer to FIGS. 1 and 3). Latching hooks 41 are integrally provided in lower end portions in the drawing of a pair of elastic legs 38, that is, leading end portions in the installed equipment 12 side, respectively. In this case, each of the latching hooks 41 is provided in such a manner as to protrude to an outer surface side of each of the elastic legs 38 or outwardly.

In this embodiment, if the vertical insertion pipe 20 of the connector main body 14 is inserted into the insertion hole 18 of the installed equipment 12, and the hook member 16 is pushed downward in the drawing, the latching hook 41 in the leading end portion of the elastic legs 38 is latched to each of a pair of latched portions 36 in the latching body 30 in the installed equipment 12 side accompanying an elastic deformation of the elastic legs 38 in an inward direction or in a direction in which the elastic legs 38 come close to each other, whereby the hook member 16 is fixed to the installed equipment 12 in a come-off preventing state, and the connector main body 14 is fixed to the installed equipment 12 in a connected state by the hook member 16. In detail, the connector main body 14 is fixed to the installed equipment 12 in a come-off preventing state on the basis of the abutting action of the come-off preventing portion 40 in the hook member 16 with respect to the top surface of the connector main body 14.

An engagement protruding portion 42 formed in a thin plate shape is integrally provided in the top surface of the connector main body 14. On the other hand, the come-off preventing portion 40 in the hook member 16 is provided with a plurality of slit-shaped engagement concave portions 44-1, 44-2 and 44-3 corresponding to the engagement protruding portion 42 respectively in different directions, in detail, at different angles in connection with a position of the nipple portion 22 in the connector main body 14 in a rotational direction around an axis of the insertion pipe 20. In this case, the engagement concave portions 44-1, 44-2 and 44-3 are respectively provided so as to intersect with each other at centers.

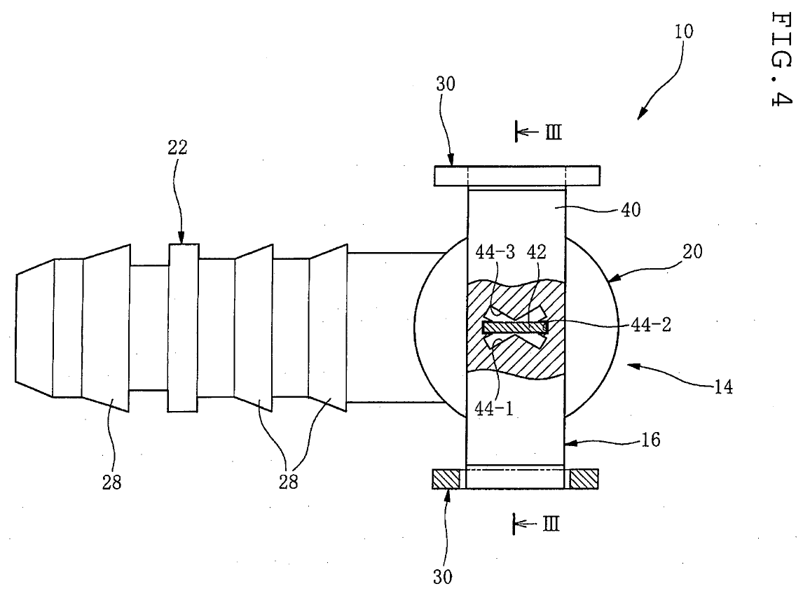

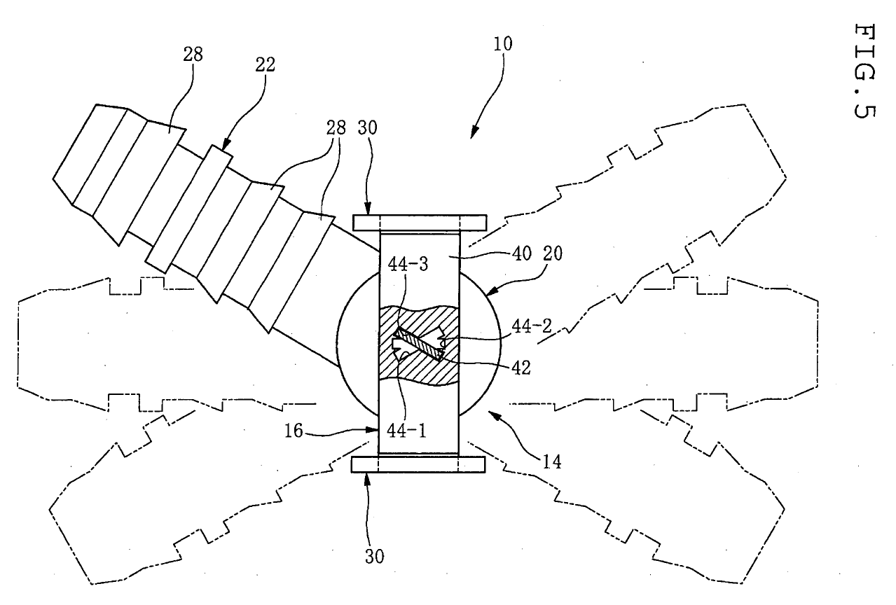

The engagement protruding portion 42 and the engagement concave portions 44-1, 44-2 and 44-3 function as a positioning means defining a rotational direction of the connector main body 14 with respect to the hook member 16, more specifically, a position of the nipple portion 22 in a rotational direction around the axis of the insertion pipe 20, and the position in the rotational direction of the connector main body 14 with respect to the hook member 16 is defined according to the engagement concave portions 44-1, 44-2 and 44-3, by engaging and inserting the engagement protruding portion 42 of the connector main body 14 to any one of the engagement concave portions 44-1, 44-2 and 44-3 of the hook member 16 as shown in FIG. 4 and FIG. 5.

Further, it is possible to change the position in the rotational direction of the connector main body 14 with respect to the hook member 16, by changing the engagement concave portions 44-1, 44-2 and 44-3 to which the engagement protruding portion 42 is engaged and inserted. In this case, the engagement protruding portion 42 and the engagement concave portions 44-1, 44-2 and 44-3 can not relatively rotate with each other in the engaged state. Accordingly, after attaching and fixing the connector main body 14 to the installed equipment 12 by the hook member 16, the connector main body 14 is in a state in which the connector main body 14 is fixed to the hook member 16 so as to be non-rotatable.

In this case, the length of the notched portion 34 in the latching body 30 in the installed equipment 12 side is approximately equal to the length of the latching body 41 as shown in FIG. 1. Accordingly, the hook member 16 can not substantially rotate with respect to the installed equipment 12 in a state in which the hook member 16 is fixed to the installed equipment 12 or prevented from coming off of the installed equipment 12 on the basis of the latching between the latching hook 41 and the latched portion 36.

In accordance with the present embodiment mentioned above, even in the case that it is necessary to change to or provide the connector main body 14 having the proper nipple portion 22 corresponding to the difference of the piping diameter, the piping type or the like of the fuel piping, it is possible to use the hook member 16 in common for each of the connector main bodies 14. Accordingly, it is possible to make a cost necessary for the first quick connector 10 inexpensive.

Further, since the engagement protruding portion 42 and the engagement concave portions 44-1, 44-2 and 44-3 defining the position in the rotational direction of the connector main body 14 with respect to the hook member 16, that is, the position in the rotational direction of the nipple portion 22 are provided in the connector main body 14 and the hook member 16, it is possible to prevent the fuel piping from being oscillated accompanied by the vehicle traveling, on the basis of the free rotation of the connector main body 14, that is, the nipple portion 22. Accordingly, it is possible to omit fixing of the portion in the vicinity of the connector of the fuel piping to vehicle body or the like using the independent clamp part for suppressing the oscillation. Therefore, it is possible to omit such a clamp part and fixing work.

Further, since the engagement protruding portion 42 and the engagement concave portions 44-1, 44-2 and 44-3 can position the connector main body 14 with respect to the hook member 16 at a plurality of different positions in the rotational direction, it is possible to change the direction (the position in the rotational direction) of the nipple portion 22 corresponding to the proper extending direction of the fuel piping, it is possible to eliminate the necessity that the fuel piping is unnecessarily lengthily routed, and it is possible to effectively shorten the routing length.

Since the engagement protruding portion 42 as the positioning means is formed in the plate shape, and the engagement concave portions 44-1, 44-2 and 44-3 as the positioning means are formed in the slit shape corresponding to the plate shape, it is possible to make the regulating force in the rotational direction large.

Further, since the length of the notched portion 34 formed in the installed equipment 12 side is set in the length at which the latching hook 41 does not rotatably move within the notched portion 34, it is possible to latch the latching hook 41 itself to the installed equipment 12 in the non-rotatable state, that is, it is possible to set the hook member 16 in the fixed state in the rotational direction with respect to the installed equipment 12. And, in accordance with this structure, it is possible to attach and fix integrally the connector main body 14 and the hook member 16 to the installed equipment 12 in a state of being defined at the position in the rotational direction.

In the present embodiment, since it is further possible to previously set the connector main body 14 and the hook member 16 to an assembled state, by engaging and inserting the engagement protruding portion 42 to the engagement concave portions 44-1, 44-2 and 44-3, and it is possible to attach and fix them to the installed equipment 12 in this state, it is possible to easily attach and fix the first quick connector 10 to the installed equipment 12 through one-touch operation. Further, in the present embodiment, there is an advantage that it is possible to differentiate the positioning position in the rotational direction of the connector main body 14 with respect to the hook member 16, by replacing the hook members 16 in FIGS. 1 to 5 with the hook member in which the engagement concave portions 44-1, 44-2 and 44-3 are formed in the different directions from the directions mentioned above.

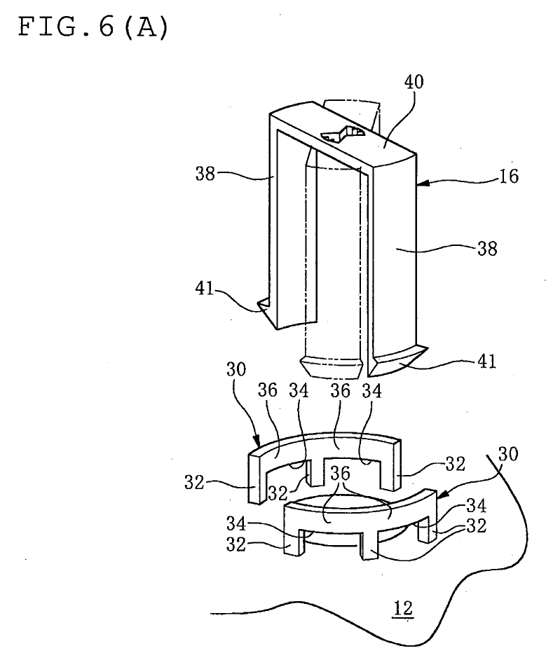

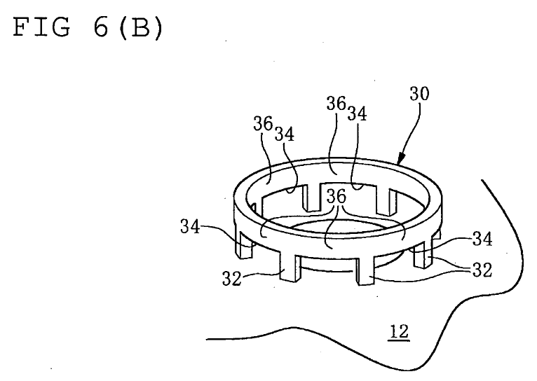

FIG. 6 shows the other embodiment of the present invention (a modified embodiment of the first quick connector 10). The embodiment in FIG. 6A is structured such that the latching bodies 30 in the installed equipment 12 side are provided in a circular arc shape, a plurality of (two in this case) notched portions 34 formed in a circular arc shape are provided to each of them, and each of the latching hooks 41 in the leading end portions of the elastic legs 38 of the hook members 16 is entered into any one of the notched portions 34, so as to be latched to each of the corresponding upper latched portions 36. In accordance with this embodiment, it is possible to change the fixed position of the hook member 16 with respect to the installed equipment 12 in the rotational direction, whereby it is possible to further increase a freedom for selecting the direction of the nipple portion 22 in the connector main body 14, that is, the position in the rotational direction. Further, an embodiment in FIG. 6B, the latching body 30 is provided to form a circular ring shape, and a lot of notched portions 34 and upper latched portions 36 are provided in its circumferential direction. In accordance with FIG. 6B, it is possible to further increase a freedom for selecting the direction of the nipple portion 22.

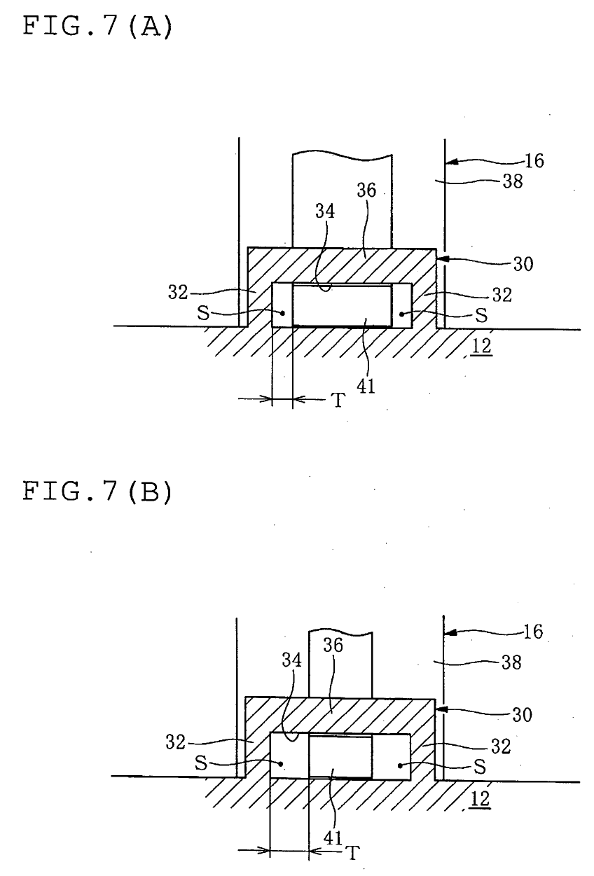

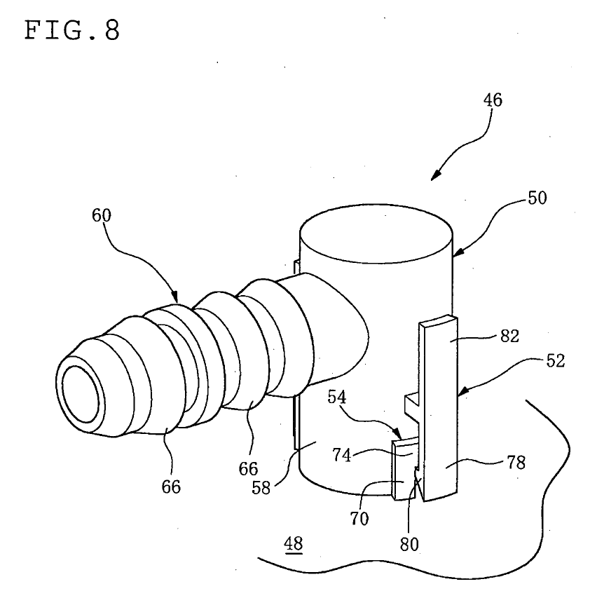

Meanwhile, in the embodiments mentioned above, a play gap is not substantially provided between the latching hook 41 and the end in the longitudinal direction of the notched portion 34, however, a play gap S may be provided between the latching hook 41 within the notched portion 34 and the end in the longitudinal direction of the notched portion 34 as shown in FIG. 7. Further, a width T of the play gap S can be appropriately changed as shown in FIGS. 7A and 7B. With the structure mentioned above, even in the case that the layout differs according to the vehicle type, it is possible to adjust the direction of the nipple portion 22 with the play gap S.

Also, in the embodiments mentioned above, the engagement protruding portion 42 is provided in the connector main body 14 side, and the engagement concave portions 44-1, 44-2 and 44-3 are provided in the hook member 16 side, however, the structure may be made conversely such that the engagement protruding portion is provided in the hook member 16 side, and the engagement concave portions are provided in the connector main body 14 side. Further, the structure may be made such that a plurality of engagement protruding portions are provided at different angles while the engagement concave portion is provided only in one direction, and the position in the rotational direction of the connector main body 14 with respect to the hook member 16 is adjusted by changing a combination of engagement between them.

In FIGS. 8 to 11, reference numeral 46 denotes a second quick connector which is attached to an installed equipment 48 such as a fuel tank, a fuel pump of the motor vehicle and couples the fuel piping such as the fuel transport tube to the installed equipment 48. The second quick connector 46 has a connector main body 50, an elastic hook portion 52 integrally provided in the connector main body 50, and a pair of latched bodies 54 provided in an exposed state on a front surface (an upper surface) of the installed equipment 48.

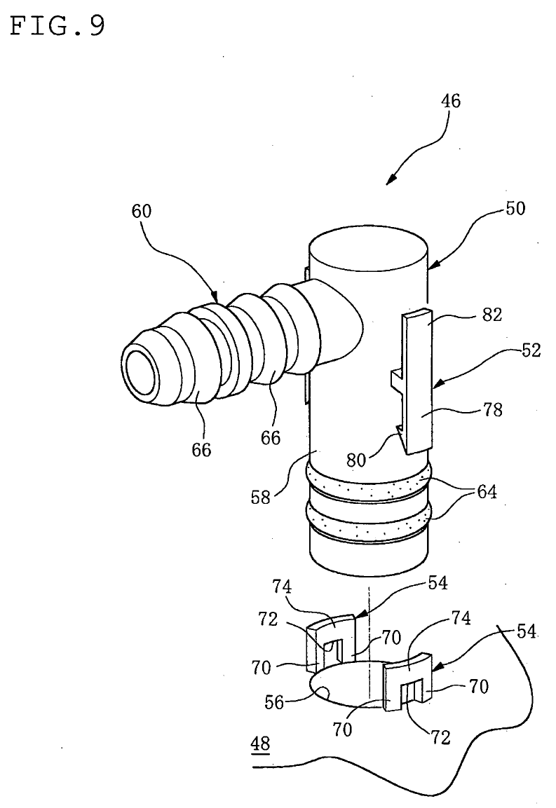

As shown in FIGS. 8 and 9, the connector main body 50 integrally has a vertical insertion pipe 58 inserted and fitted into an insertion hole 56 of the installed equipment 48, and a tubular nipple portion 60 formed in a perpendicularly lateral direction to the insertion pipe 58 and inserted into the fuel piping.

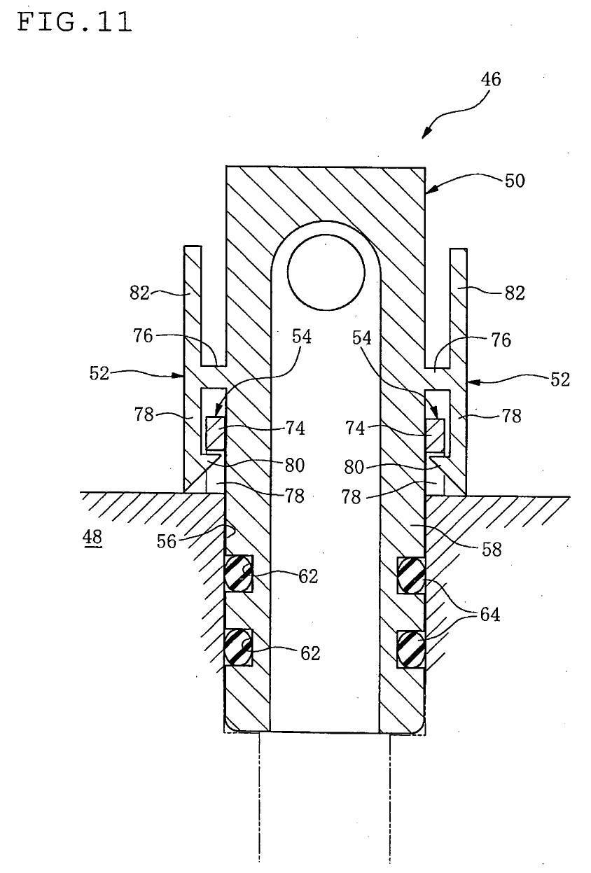

In the insertion pipe 58, as shown in FIG. 11, an annular O-ring groove 62 is formed on an outer peripheral surface thereof at a position within the insertion hole 56, and an O-ring 64 serving as a seal ring is retained there. The insertion pipe 58 is sealed with respect to the insertion hole 56 on the basis of an elastic contact with an inner peripheral surface of the insertion hole 56 of the O-ring 64, under a state in which the insertion pipe 58 is inserted and fitted into the insertion hole 56. On the other hand, annular come-off preventing projections 66 are provided at a plurality of positions in an axial direction on an outer peripheral surface of the laterally directed nipple portion 60. The annular come-off preventing projections 66 allow the nipple portion 60 to move in an inserting direction with respect to the fuel piping at a time of insertion thereof to the fuel piping. On the contrary, an outer peripheral end portion forming an acute angle of the annular come-off preventing projection 66 eat into an inner surface of the fuel piping so as to execute a come-off preventing operation in an opposite direction.

A latched body 54 provided on a front surface of the installed equipment 48 is formed in a circular arc shape as a whole and is formed in an approximately C-shape in a front elevational shape, has a pair of legs 70 and a notched portion 72 at a position between the legs 70 and 70, and is provided with a latched portion 74 coupling a pair of legs 70 and 70 in an upper side of the notched portion 72. In this case, the latched body 54 is provided, as shown in FIG. 11, such that each of the latched portions 74 is positioned in the vicinity of an outer peripheral surface of the insertion pipe 58 in a front side of the installed equipment 48 and in an upper side at a predetermined distance from the front surface.

Each of a pair of elastic hook portions 52 has a base portion 76 protruding to an outer side in radial direction from an approximately vertically intermediate position of an exposing portion outside the insertion hole 56, an elastic leg 78 suspended downward from a leading end of the base portion 76, and a latching hook 80 provided in a lower end portion of the elastic leg 78. In this case, the elastic leg 78 is positioned in an outer side rather than the latched portion 74 in the latched body 54, and the latching hook 80 is formed inward toward the insertion pipe 58 and is latched inward to the latching portion 74 from an outer side.

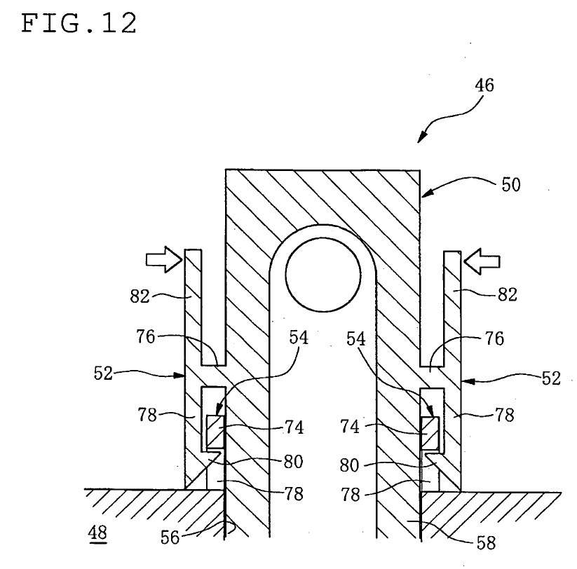

A release knob 82 rising upward from the base portion 76 is integrally provided in each of a pair of elastic hook portions 52. The release knob 82 is elastically deformed in inward and outward directions integrally with the elastic leg 78. In detail, when applying an operating force to the release knob 82 in a direction of an arrow in FIG. 12, the release knob 82 is elastically deformed inward in the drawing on the base portion 76 as a fulcrum, and the elastic leg 78 is elastically deformed in an outward opening direction on the base portion 76 as a fulcrum. At this time, the latching hook 80 is of course displaced in an outward opening direction integrally with the elastic leg 78, and cancels the latching with respect to the latched portion 74.

The second quick connector 46 in accordance with the present embodiment is structured such that when inserting the insertion pipe 58 to the insertion hole 56 of the installed equipment 48 and pressing the connector main body 50 downward as it is, the latching hook 80 is latched internal to the latched portion 74 from the outer side accompanying an elastic deformation of the elastic leg 78 in the elastic hook portion 52. In this case, the second quick connector 46 is fixed to the installed equipment 48 in a come-off preventing state.

In the present embodiment mentioned above, since the latched portion 74 of the latched body 54 is brought into contact laterally with the outer peripheral surface of the insertion pipe 58 of the second quick connector 46 in the front side of the installed equipment 48, it is possible to suppress a tilting motion of the second connector 46. In other words, the latched portion 74 can be operated as a lateral stopper with respect to the second quick connector 46, more specifically, the insertion pipe 58, whereby even in the case that the second quick connector 46 is exposed to the vehicle body vibration, it is possible to retain the second quick connector 46 in a stable attitude.

Accordingly, it is possible to dissolve the risk that the O-ring 64 sealing between the insertion pipe 58 of the second quick connector 46 and the insertion hole 56 is rubbed or damaged by the tilting motion of the second quick connector 46, whereby the sealing performance is lowered. Further, in the present embodiment, there is provided the release knob 82 canceling the latching of the latching hook 80 with respect to the latched portion 74 on the basis of the lever operation, and it is possible to easily cancel the latching by the latching hook 80 on the basis of the small force, by pushing the release knob 82 inward.

Further, since it is possible to cancel the latching by the latching hook 80 by means of the release knob 82, it is possible to shorten the length of the elastic leg 78 so as to make the elastic force strong, whereby it is possible to obtain the strong latching force of the latching hook 80 with respect to the latched portion 74. In this case, it is possible to further stabilize the attaching attitude of the second quick connector 46.

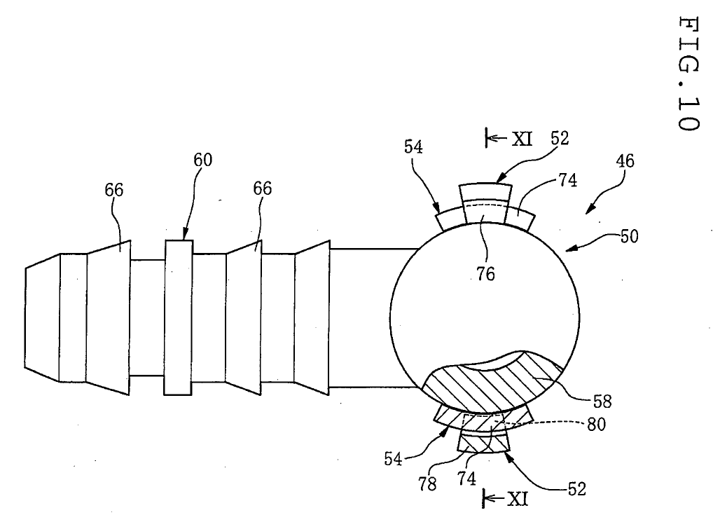

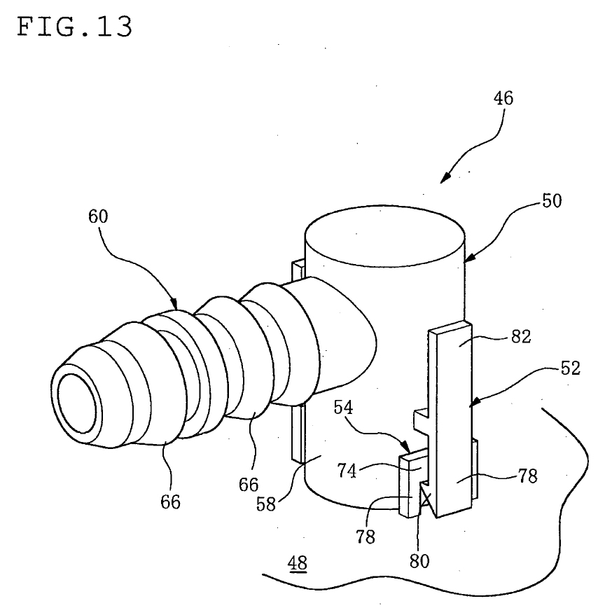

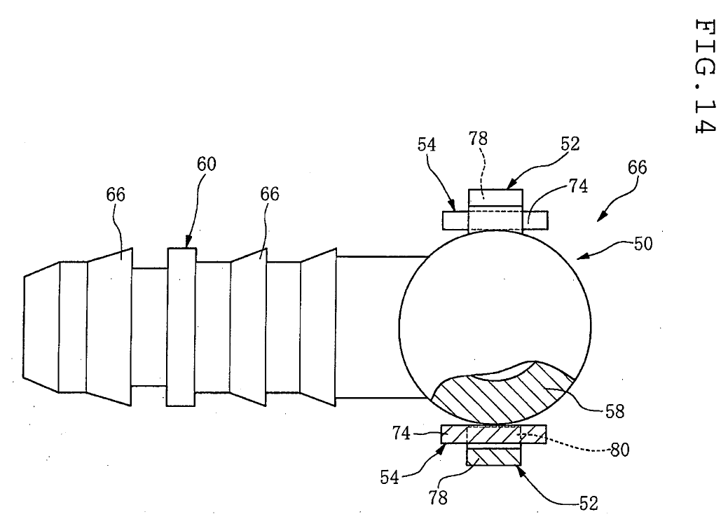

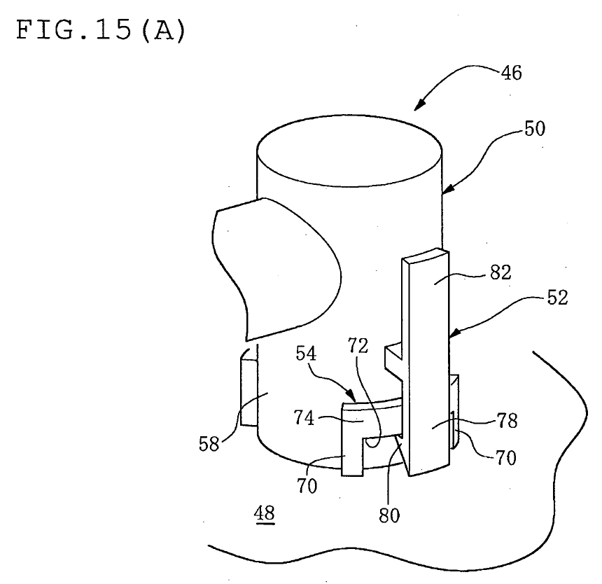

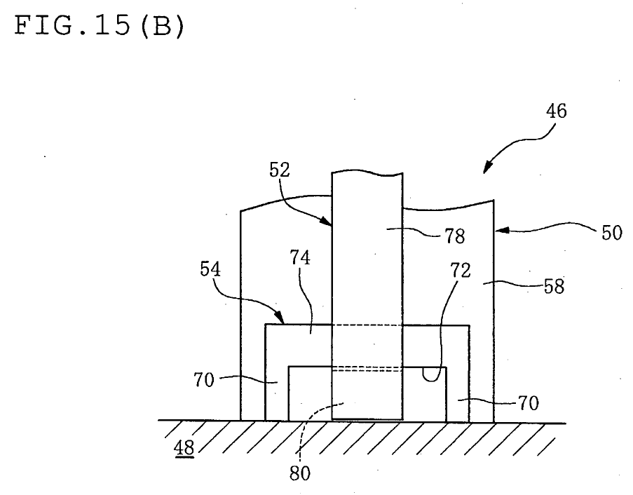

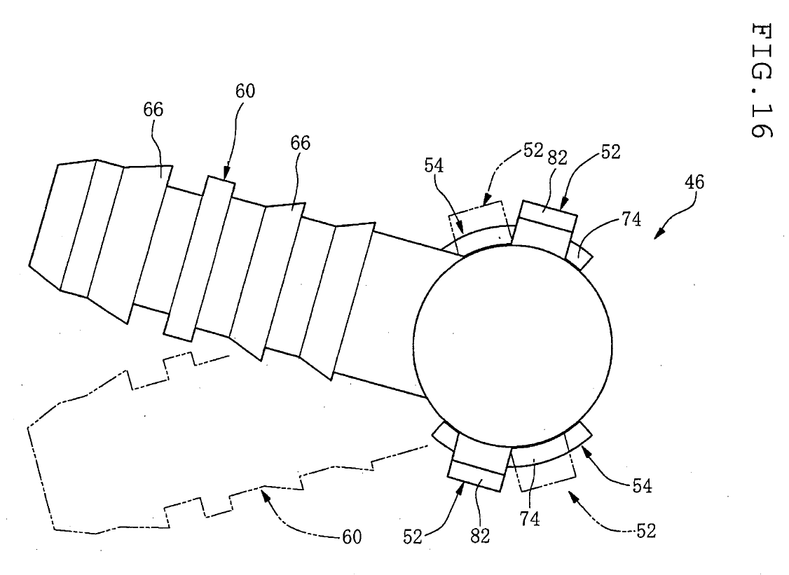

Further, in the second quick connector 46, since the elastic hook portion 52 is integrally provided in the connector main body 50, the number of the desired parts can be reduced, and it is possible to easily attach and fix the connector main body 50 to the installed equipment 48 only by pushing the connector main body 50 downward. And, in the embodiment mentioned above, as shown in FIG. 10, the latched body 54, the elastic leg 78 and the latching hook 80 in the leading end portion thereof are structured in the circular arc shape or the circular arc cross-sectional shape, however, they may be formed all in a flat shape with no curve, as shown in FIGS. 13 and 14. Further, as shown in FIGS. 15 and 16, the structure may be made such that the latched body 54 is formed in a circular arc shape or circular arc cross-sectional shape, the length in the peripheral direction of the notched portion 72 is made longer than the latching hook 80, and the latching hook 80 can relatively move in the peripheral direction within the notched portion 72.

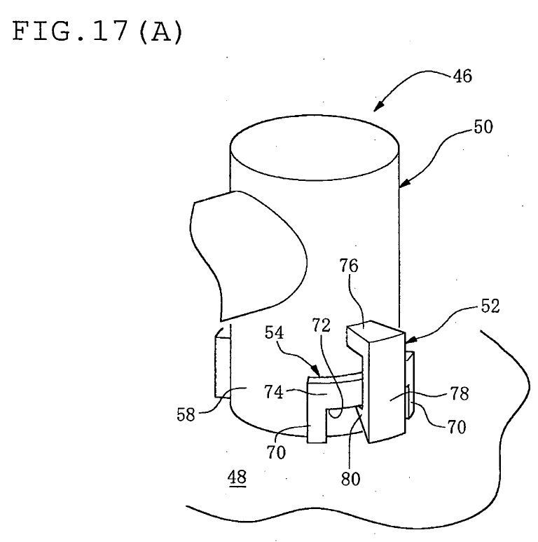

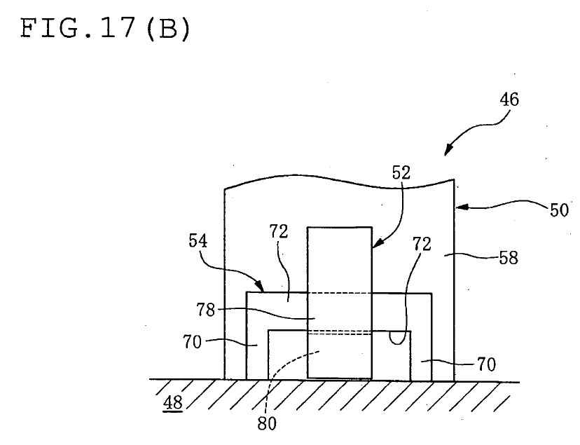

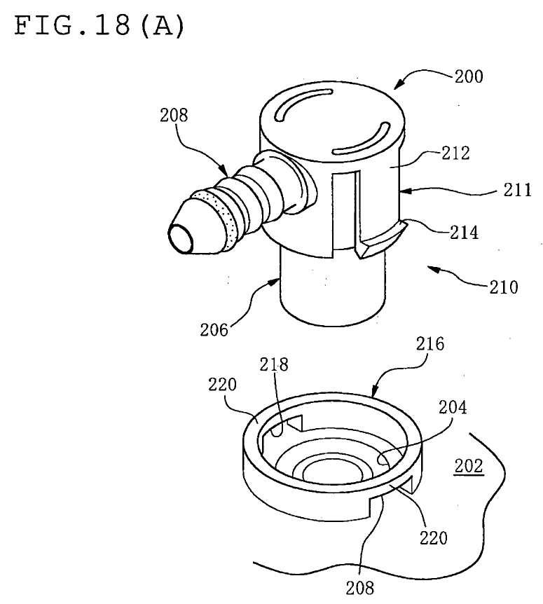

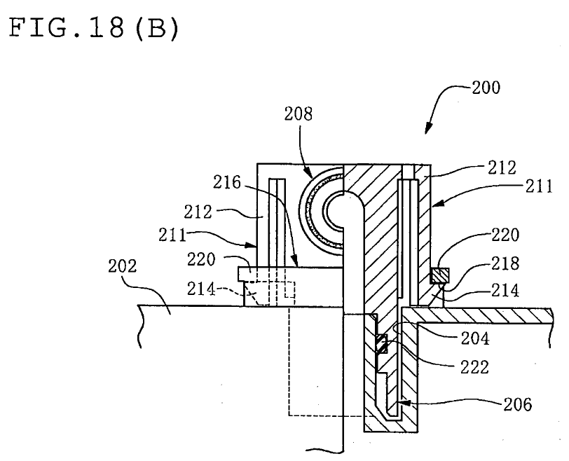

In this case, as shown in FIG. 16, there can be obtained an advantage that it is possible to freely change the direction of the nipple portion 60 within a predetermined angle range defined by the length in the peripheral direction of the notched portion 72. Further, in the embodiment mentioned above, the release knob 82 is provided in the elastic hook portion 52, however, as shown in FIG. 17, the elastic hook portion 52 can be structured without the release knob 82 as occasion demands. In this case, there can be obtained an advantage that the latching of the latching hook 80 does not come off even if any external force is applied inward to the elastic hook portion 52 (the latching comes off under such external force in the conventional structure in FIG. 18).

The description is in detail given above of the embodiments in accordance with the present invention, however, these are described only for exemplification. For example, the O-rings 26 and 64 are retained in the outer peripheral surfaces of the insertion pipes 20 and 58 of the connector main bodies 14 and 50, and the O-rings 26 and 64 are brought into elastic contact with the inner surfaces of the insertion holes 18 and 56 so as to achieve the seal, however, the structure can be made such that the O-rings 26 and 64 are retained in the inner peripheral surface sides of the insertion holes 18 and 56, and the outer peripheral surfaces of the insertion pipes 20 and 58 are brought into elastic contact with the O-rings 26 and 64, thereby achieving the seal. Further, the structure can be made such that inner pipes are provided in the insertion holes 18 and 56 in the installed equipments 12 and 48 side, the insertion pipes 20 and 58 are fitted to the inner pipes in an outward insertion state, and the outer peripheral surfaces of the inner pipes and the inner peripheral surface of the insertion pipes 20 and 58 can be sealed via the seal ring such as the O-rings 26 and 64, as occasion demands. In addition, the present invention can be structured by various aspects which are modified within the scope of the present invention.

What is claimed is:

1. A quick connector for a fuel piping, comprising:
(a) a connector main body having a vertical insertion pipe inserted and fitted into an insertion hole of a mating side fuel line equipment such as a fuel tank, and a tubular nipple portion formed laterally with respect to the insertion pipe and inserted into the fuel piping; and
(b) an elastic hook portion including an elastic leg having a latching hook elastically latched to a latched portion provided in the fuel line equipment in a leading end portion in the fuel line equipment side, the elastic hook portion elastically latching the latching hook to the latched portion by being pressed in an axial direction so as to fix the connector main body to the fuel line equipment in a come-off preventing state,
wherein the elastic hook portion is structured such that the latching hook is formed inward with respect to the insertion pipe and latched to the latched portion inward from an outer side, or the elastic hook portion includes a come-off preventing portion achieving a come-off prevention on the basis of an abutting action against the connector main body, and is structured as an independent body from the connector main body.

2. The quick connector for a fuel piping as set forth in claim 1, wherein the elastic hook portion includes the come-off preventing portion achieving the come-off prevention on the basis of the abutting action against the connector main body, and is structured as an independent body from the connector main body, and
wherein a positioning means for defining a position in a rotational direction of the connector main body around an axis of the insertion pipe with respect to the elastic hook portion is arranged astride the connector main body and the elastic hook portion.

3. The quick connector for a fuel piping as set forth in claim 2, wherein the positioning means is capable of positioning the connector main body to each of a plurality of different positions in the rotational direction with respect to the elastic hook portion.

4. The quick connector for a fuel piping as set forth in claim 2, wherein the positioning means has an engagement protruding portion provided to one of the connector main body and the elastic hook portion, and an engagement concave portion provided to the other, and positions the connector main body on the basis of an engaging operation therebetween.

5. The quick connector for a fuel piping as set forth in claim 3, wherein the positioning means has an engagement protruding portion provided to one of the connector main body and the elastic hook portion, and an engagement concave portion provided to the other, and the engagement protruding portion and the engagement concave portion are engaged so as to be non-rotatable with each other at different positions in the rotational direction.

6. The quick connector for a fuel piping as set forth in claim 4, wherein the engagement protruding portion is formed in a plate shape, and the engagement concave portion is formed in a slit shape corresponding to the plate shape.

7. The quick connector for a fuel piping as set forth in claim 1, wherein the elastic hook portion includes the come-off preventing portion achieving the come-off prevention on the basis of the abutting action against the connector main body, and is structured as an independent body from the connector main body, and
wherein the elastic hook portion is formed in a gantry shape provided with at least a pair of the elastic legs and a coupling portion coupling the elastic legs in an end portion in an opposite side to the latching hook, and the coupling portion forms the come-off preventing portion.

8. The quick connector for a fuel piping as set forth in claim 1, wherein the latching hook enters into a notched portion formed in a side of the fuel line equipment so as to be latched to the latched portion, and a length of the notched portion is set to a length at which the latching hook does not rotationally move within the notched portion.

9. The quick connector for a fuel piping as set forth in claim 8, wherein the notched portion is provided at a plurality of positions around the insertion hole, and the latching hook enters into any one of the notched portions so as to be latched to the latched portion.

10. The quick connector for a fuel piping as set forth in claim 1, wherein the elastic hook portion is structured such that the latching hook is formed inward with respect to the insertion pipe, and is latched to the latched portion inward from the outer side, and
wherein the latched portion is formed in a latched body provided in a front side of the fuel line equipment in a fixed state, and is positioned around the insertion pipe in the connector main body in the front side of the fuel line equipment.

11. The quick connector for a fuel piping as set forth in claim 10, wherein the elastic hook portion is integrally provided in the insertion pipe of the connector main body.

12. The quick connector for a fuel piping as set forth in claim 10, wherein the elastic hook portion is provided with a release knob canceling the latching of the latching hook with respect to the latched portion on the basis of a lever operation.
